(19) United States
(12) Patent Application Publication
(10) Pub. No.: US 2018/0332781 A1
(43) Pub. Date: Nov. 22, 2018

(54) Mulch Tiles

(71) Applicant: Michael Dougherty, Cleveland, OH (US)

(72) Inventor: Michael Dougherty, Cleveland, OH (US)

(21) Appl. No.: 15/985,072

(22) Filed: May 21, 2018

Related U.S. Application Data
(60) Provisional application No. 62/508,576, filed on May 19, 2017.

(51) Int. Cl. A01G 13/02

(52) U.S. Cl. CPC A01G 13/0268; B30B 9/3003; A01G 13/0262

(57) ABSTRACT

A landscape product includes a compressed mulch tile having a top surface, a bottom surface, and a height between the top and bottom surfaces. The compressed mulch tile is made from loose mulch that has been dried, compressed and adhered together. A sheet of landscape fabric is adhered to the bottom surface of the compressed mulch tile.

This U.S. patent application claims priority to and benefit of U.S. provisional patent application Ser. No. 62/508,576 filed on May 19, 2017, which is incorporated herein by reference in its entirety.

### TECHNICAL FIELD

In general, the present invention relates to a landscape product, in particular compressed mulch tiles.

### BACKGROUND OF THE INVENTION

Mulch may be applied to the surface of soil for conservation of soil moisture, improving health of the soil, reducing weed growth, and enhancing visual appearance. Mulch is usually organic, such as bark chip mulch.

### SUMMARY OF THE INVENTION

According to one aspect of the disclosure, a landscape product is provided having a sheet of landscape fabric and a compressed mulch tile adhered to the landscape fabric. The compressed mulch tile has a top surface, a bottom surface, and a depth, wherein the compressed mulch tile is loose mulch that has been dried, compressed and adhered together.

According to one embodiment, the landscape product further includes a plurality of compressed mulch tiles arranged on the sheet of landscape fabric, in an array spaced from one another.

According to one embodiment, the array of compressed mulch tiles on the fabric is folded and stitched together with a biodegradable stitch to form a carrying case.

According to one embodiment, the top surface of the compressed mulch tile has a concave indentation.

According to one embodiment, the concave indentation has an indentation depth that is at least 1/10^{th} of the depth of the tile.

According to one embodiment, the top surface of the compressed mulch tile comprises a plurality of holes.

According to one embodiment, each of the plurality of holes has a diameter greater than 1/16^{th} of an inch, but less than ½ of an inch.

According to one embodiment, the plurality of holes are spaced at approximately one hole per square inch.

According to another aspect of the disclosure, a method of forming a compressed mulch tile includes placing a sheet of landscape fabric on a conveyor belt, placing a mold on top of the landscape fabric, drying loose mulch, feeding the loose mulch into the mold, pressing the loose mulch with a press, forming the loose mulch into a compressed mulch tile on top of the sheet of landscape fabric, and removing the press from the mold.

According to one embodiment, the method further includes applying at least one of water, resin, sap, gum, or lignin to a surface of the sheet of landscape fabric before forming the compressed mulch tile on top of the sheet of landscape fabric.

According to one embodiment, the sheet of landscape fabric includes perforations at spaced intervals from one another to allow for separation of mulch tiles.

According to one embodiment, the press includes a head having a convex shape and/or one or more extension lines that imprint a concave cavity and/or one or more lines onto a top surface of the compressed mulch.

According to one embodiment, as the press compresses the loose mulch, lignin within the mulch is liquefied and self-distributed among mulch particles to hold the mulch particles together and to hold the mulch to the landscape fabric.

According to one embodiment, the method further includes mixing a water-soluble adhesive with the loose mulch before feeding the loose mulch into the mold.

According to one embodiment, the loose mulch is dried to less than 6% moisture content.

According to one embodiment, the loose mulch is pressed at a pressure between 12,250 psi and 17,000 psi.

According to one embodiment, the mulch is dried to approximately 1% moisture content, and a resin, sap, gum, or lignin is mixed with the loose mulch.

According to one embodiment, the method includes embedding holes into the compressed mulch tile.

According to one embodiment, the holes are greater than 1/16 of an inch and less than ½ of an inch.

According to another aspect of the disclosure, a method of manufacturing a landscape product includes drying loose mulch, compressing a first portion of the loose mulch, forming the first portion of loose mulch into a first compressed mulch tile, adhering the first compressed mulch tile to a landscape fabric, compressing a second portion of the loose mulch, forming the second portion of loose mulch into a second compressed mulch tile, adhering the second compressed mulch tile to the landscape fabric spaced a distance away from the first compressed mulch tile, folding or rolling the landscape fabric to contain the first compressed mulch tile and the second compressed mulch tile, and fastening the landscape fabric to at least partially enclose the first compressed mulch tile and the second compressed mulch tile within the landscape fabric.

These and other objects of this invention will be evident when viewed in light of the drawings, detailed description and appended claims.

### BRIEF DESCRIPTION OF THE DRAWINGS

The invention may take physical form in certain parts and arrangements of parts, a preferred embodiment of which will be described in detail in the specification and illustrated in the accompanying drawings which form a part hereof, and wherein:

FIG. 1 is a perspective view of an exemplary mulch tile.

FIG. 2 is a top view of the mulch tile.

FIG. 3 is a perspective view of a mulch tile attached to landscape fabric.

FIG. 4 is a top view of the mulch tile and landscape fabric.

FIG. 5 is a perspective view of an array of mulch tiles on landscape fabric.

FIG. 6 is a top view of the mulch tiles on landscape fabric.

FIG. 7 is a schematic view of an array of mulch tiles on landscape fabric.

FIG. 8 is a partially folded view of the array of FIG. 7.

FIG. 9 is another partially folded view of the array of FIG. 7.

FIG. 10 is a folded view of the array of FIG. 7.

FIG. 11 is a perspective schematic view of an array of mulch tiles on landscape fabric partially rolled.

FIG. 12 is a front schematic view of the array of FIG. 11.

FIG. 13 is a top schematic view of the array of FIG. 11.

FIG. 14 is a side view of a mulch tile carrying case.

FIG. 15 is a top perspective view of the carrying case.

FIG. 16 is another side view of the carrying case.

FIG. 17 is a schematic view of the carrying case unfolded.

FIG. 18 is a front view of an exemplary sleeve.

FIG. 19 is a perspective view of the sleeve.

FIG. 20 is another perspective view of the sleeve.

FIG. 21 is a view of a top of the sleeve.

FIG. 22 is a front view of the sleeve holding a plurality of mulch tiles.

FIG. 23 is a perspective view of the sleeve holding the plurality of mulch tiles.

FIG. 24 is a top view of the sleeve holding the plurality of mulch tiles.

FIG. 25a is a schematic view of an exemplary system for forming the mulch tiles.

FIG. 25b is a schematic view of an exemplary system for forming the mulch tiles.

FIG. 26 is a top view of a mulch tile with holes embedded in the tile.

FIG. 27 is a schematic view of an exemplary mulch receptacle.

### DETAILED DESCRIPTION OF THE INVENTION

Embodiments of the invention relate to methods and systems that relate to mulch tiles.

With reference to the drawings, like reference numerals designate identical or corresponding parts throughout the several views. However, the inclusion of like elements in different views does not mean a given embodiment necessarily includes such elements or that all embodiments of the invention include such elements. The examples and figures are illustrative only and not meant to limit the invention, which is measured by the scope and spirit of the claims.

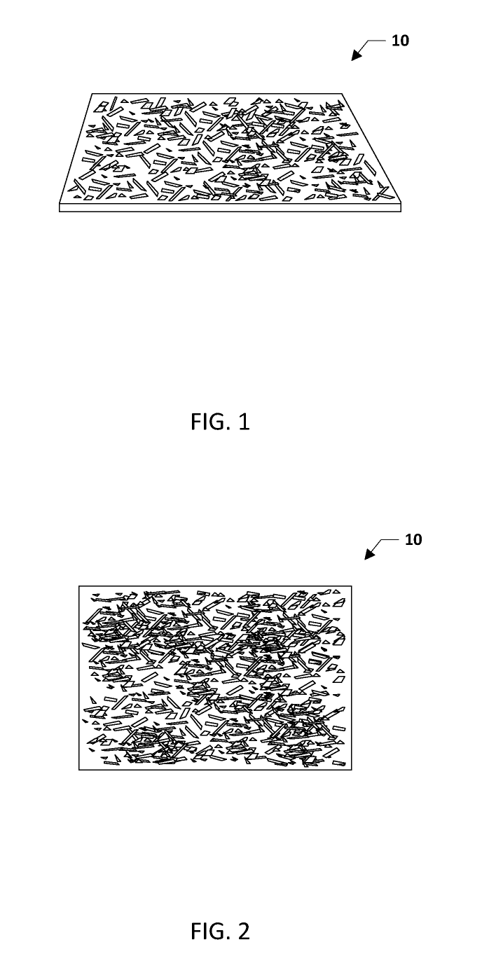

Turning now to FIGS. 1 and 2, an exemplary mulch tile is illustrated at reference numeral 10. The mulch tile 10 is shown as a rectangular tile, although it will be appreciated that any suitable shape, such as a square, circle, hexagon, etc. may be provided. The mulch tile is formed by compressing mulch, such as bark mulch, as described below. The mulch tile is designed to be placed on a surface, such as in a landscape bed around a house, in a spaced relationship to other mulch tiles. The tile can then be watered, which causes the mulch tile 10 to expand vertically and laterally to cover a predefined area.

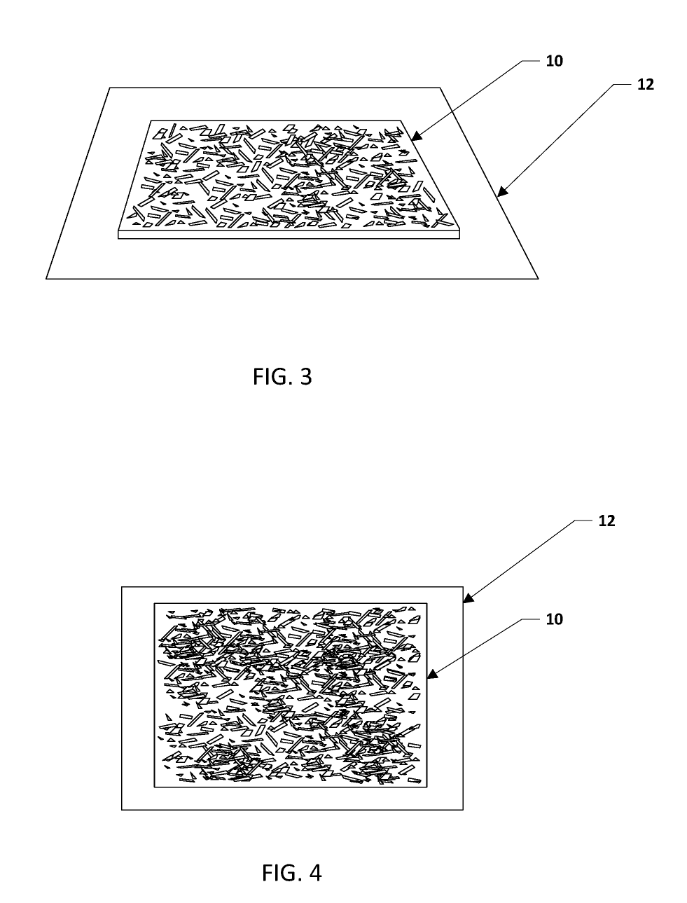

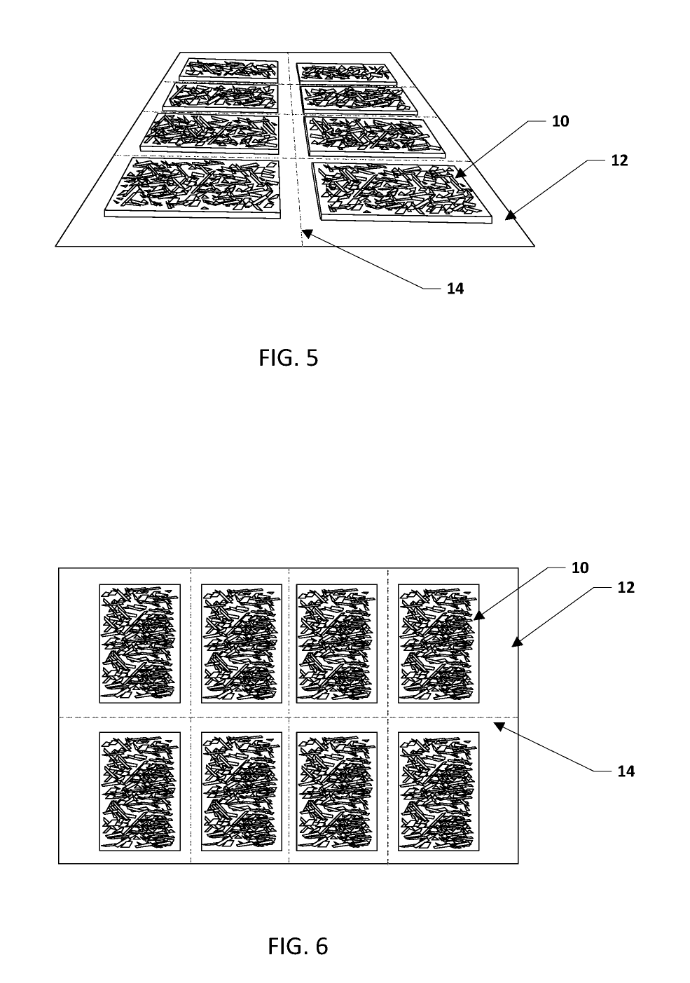

Turning now to FIGS. 3-6, the mulch tile 10 is shown attached to a substrate, such as landscape fabric 12. A single tile 10 and fabric 12 can be provided as shown in FIGS. 3 and 4 or a plurality of tiles 10 provided in an array as shown in FIGS. 5 and 6. The array can include any suitable number of tiles 10, and the landscape fabric 12 can be attached to adjacent fabrics 12 and separable in a suitable manner, such as by perforations 14. When provided in an array, the mulch tiles 10 can be placed in a landscaping bed and the tiles 10 separated as required to cover the area of the bed. The single tiles or the array of tiles can be watered to cause the mulch to separate from the fabric 12 and expand vertically and laterally to cover a predefined area. As such, the tiles are easily handled and require little to no action by a user other than providing water.

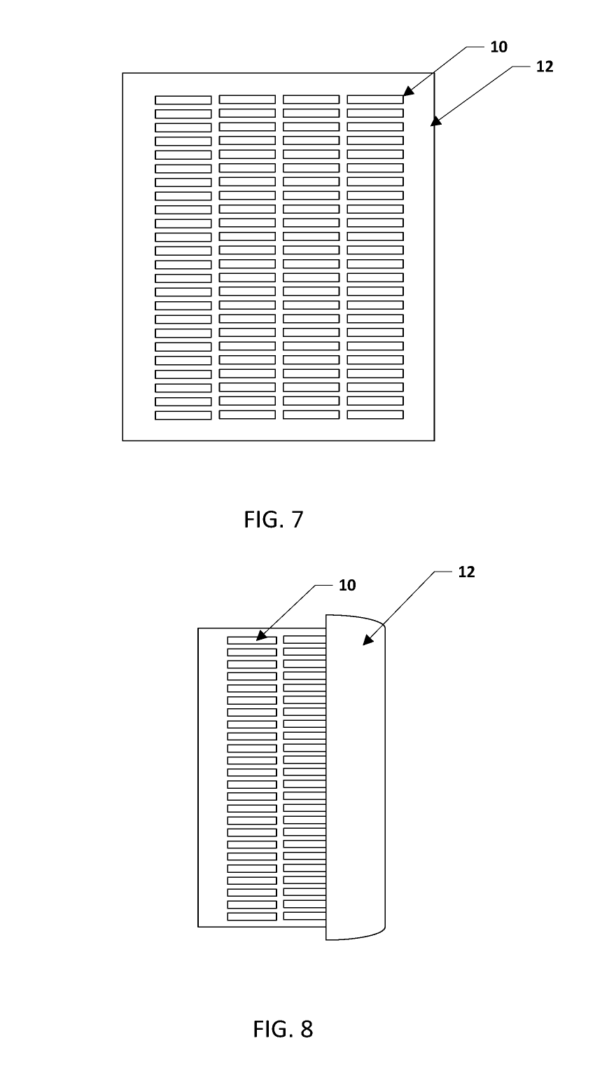

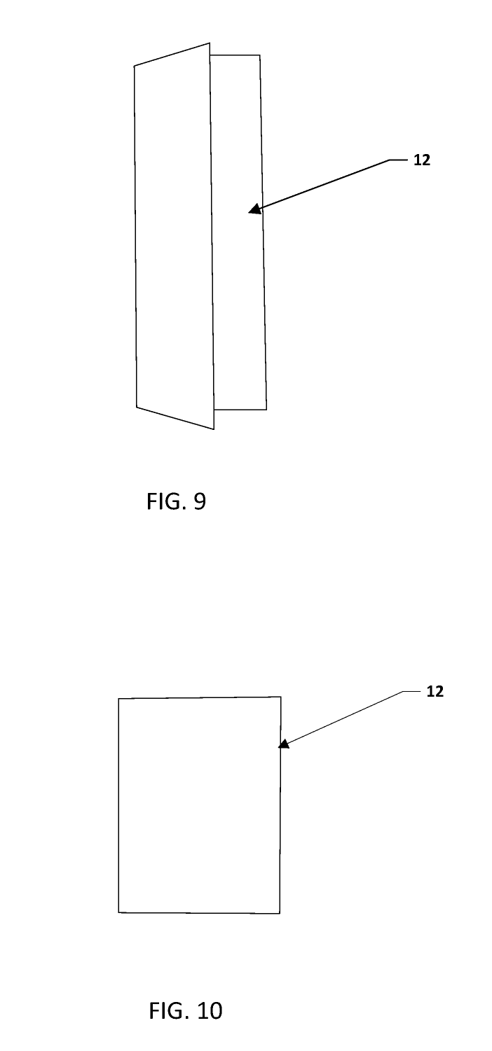

Turning now to FIGS. 7-10, the plurality of tiles 10 attached to fabric 12 is illustrated in an array. For storage/transportation, the array can be folded in a suitable manner, such as by folding the array in thirds as shown in FIGS. 8 and 9, and then in half as shown in FIG. 10.

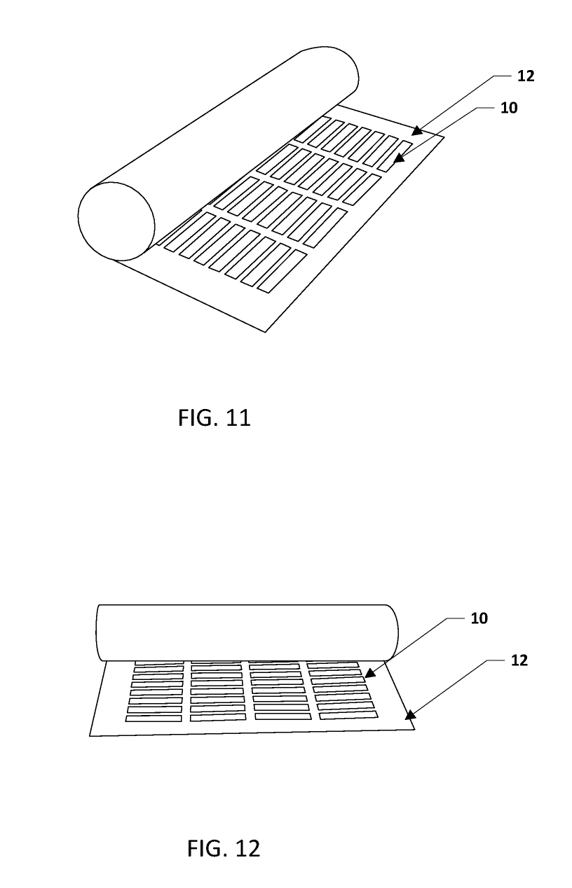

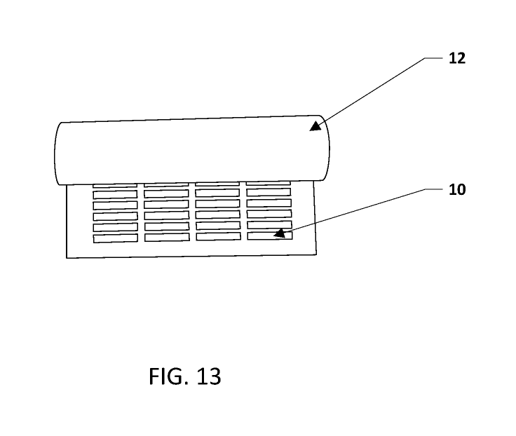

Turning now to FIGS. 11-13, the plurality of tiles 10 attached to fabric 12 is illustrated in an array. For storage/transportation, the array can be rolled as shown. In certain embodiments, the rolled array can be placed onto a spool or other dispensing apparatus such that a user can remove or dispense portions of the rolled array as necessary for an application.

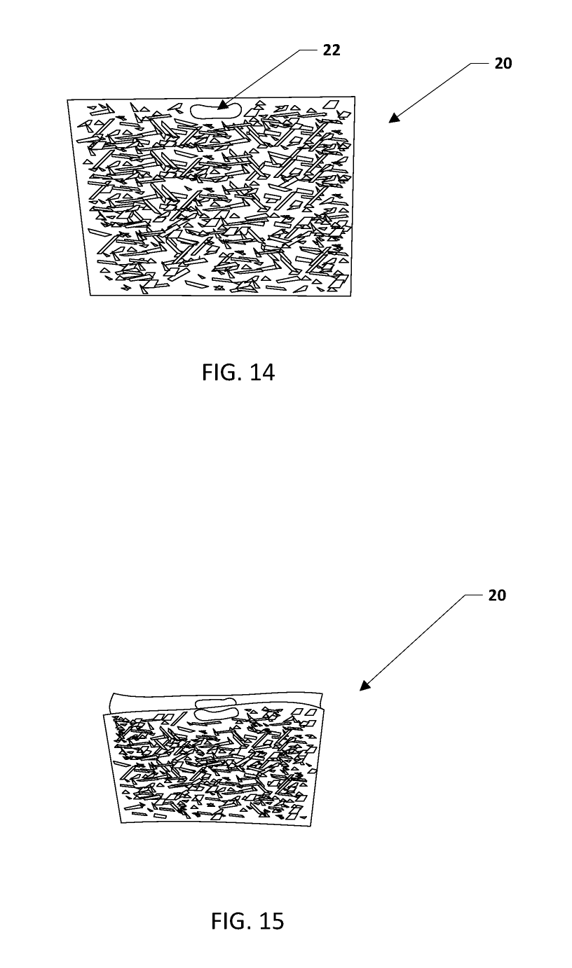

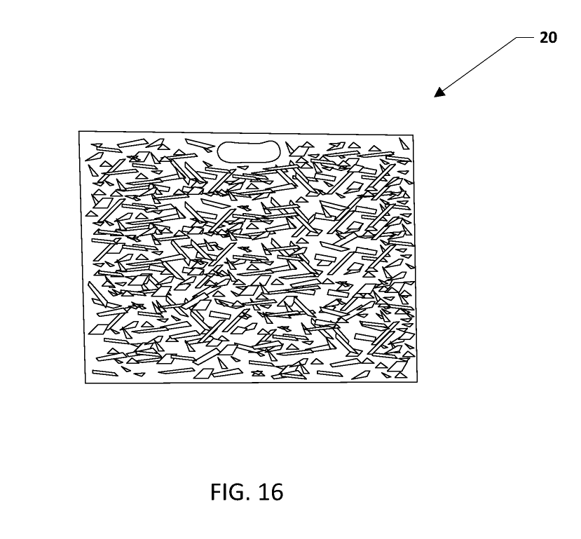

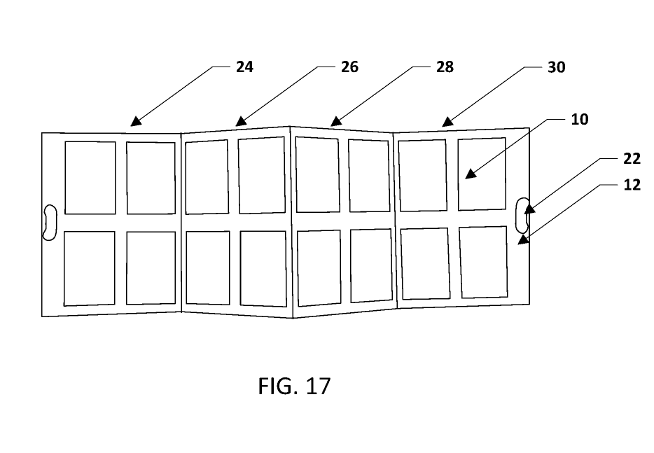

Turning now to FIGS. 14-17, an array of tiles 10 on fabric 12 can be folded to form a carrying case 20 having one or more handles 22. For example, as shown in FIG. 17, the array includes four two by two arrays shown as arrays 24, 26, 28, and 30. The arrays 24 and 30 each include a handle 22 in the form of a cut-out formed in the landscape fabric 12. To fold the array into the carrying case 20, the arrays 24 and 26 are folded toward one another such that the tiles 10 of the array 24 contact the tiles 10 of the array 26, and the arrays 28 and 30 are folded toward one another such that the tiles 10 of the array 28 contact the tiles 10 of the array 30. The arrays are then folded such that the bottom of the arrays 26 and 28 contact one another. The arrays may be fastened together in any suitable manner, such as by a quick release stitch that is biodegradable. In this way, the tiles 10 can be easily transported, and the case 20 can be disassembled without a tool while providing a zero-waste package.

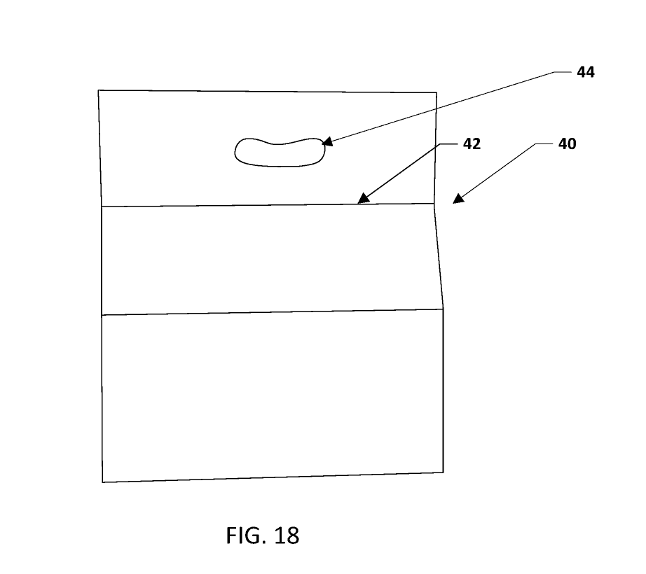

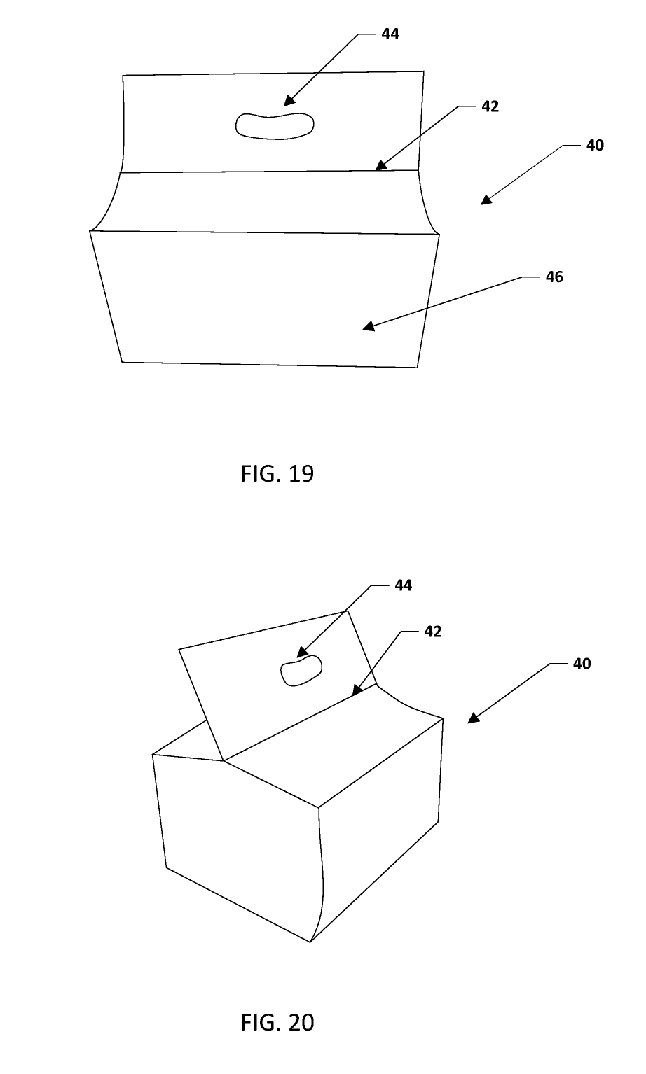

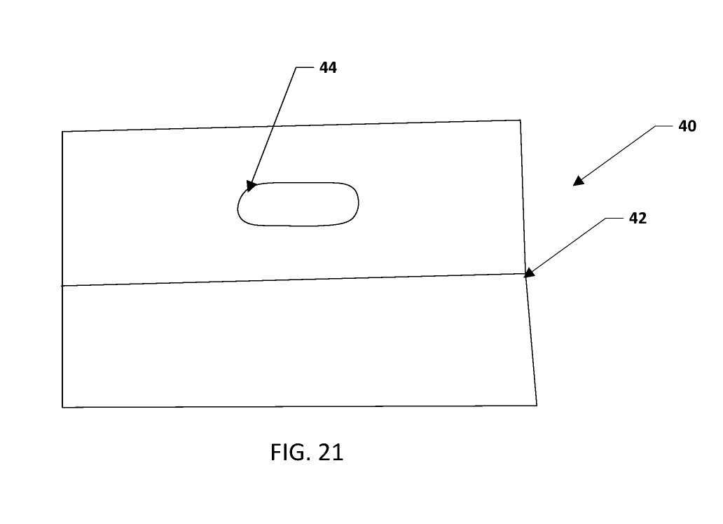

Turning now to FIGS. 18-21, a sleeve 40 for carrying a plurality of tiles 10 is shown. The sleeve 40 can be formed by folding landscape fabric and then holding the fabric together using stitch 42, such as a quick release stitch, such that ends of the fabric sleeve having handles 44 in the form of a cut-out overlap one another for carrying. A label may be attached to the fabric on one or more sides.

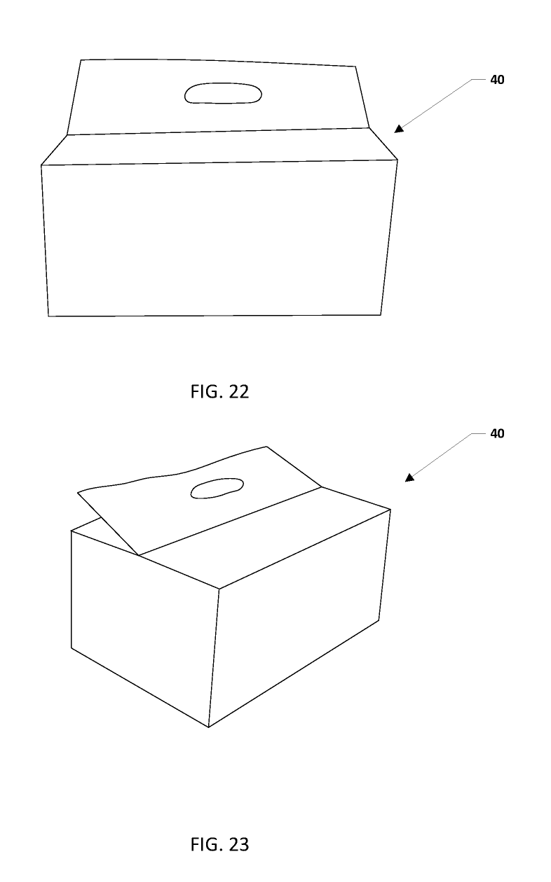

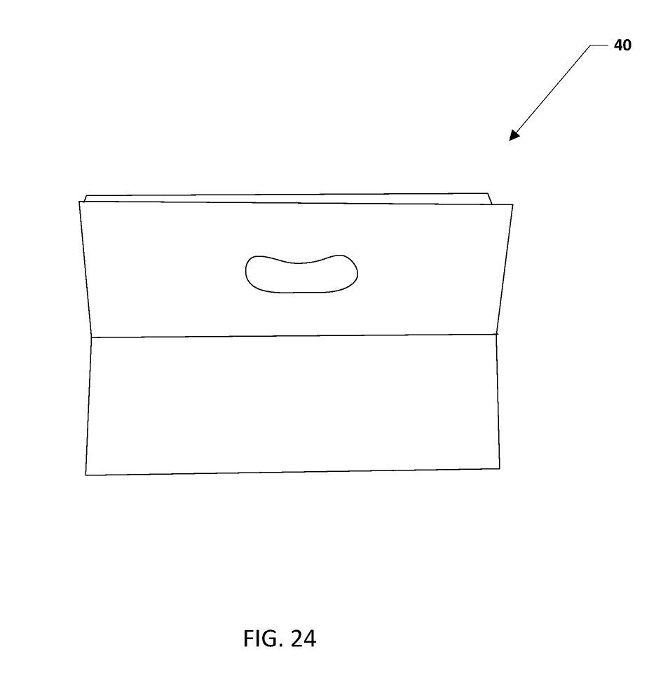

Turning now to FIGS. 22-24 in addition to FIGS. 18-21, the sleeve 40 is shown surrounding a plurality of tiles 10 attached to fabric 12. The tiles 10 attached to fabric 12 may be in arrays as discussed above or may be provided individually as shown in FIG. 3. When in an array, the array may be folded in any suitable manner. It will be appreciated, however, that tiles 10 unattached to fabric may be held in the sleeve and then during use, the fabric placed on the ground and the tiles 10 placed over the fabric.

Exemplary methods of forming the tiles 10 with or without landscape fabric 12 will now be described.

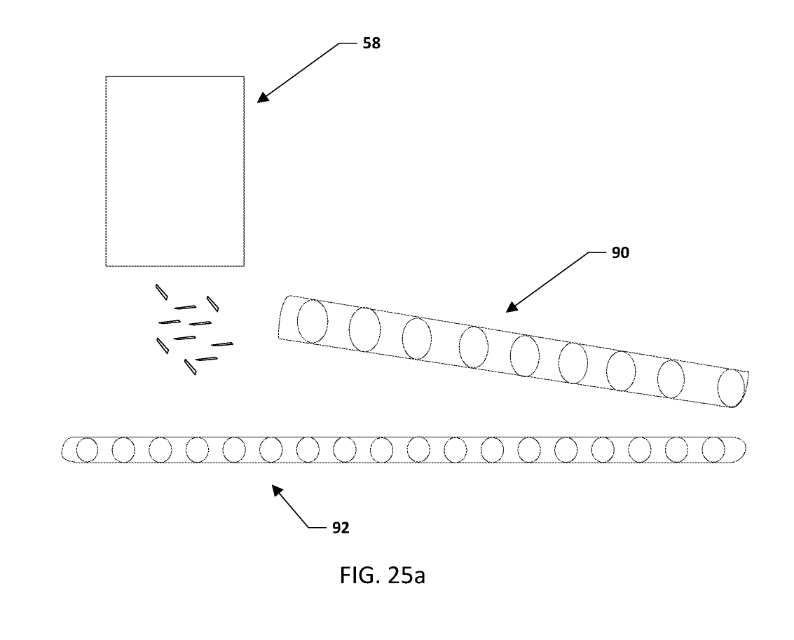

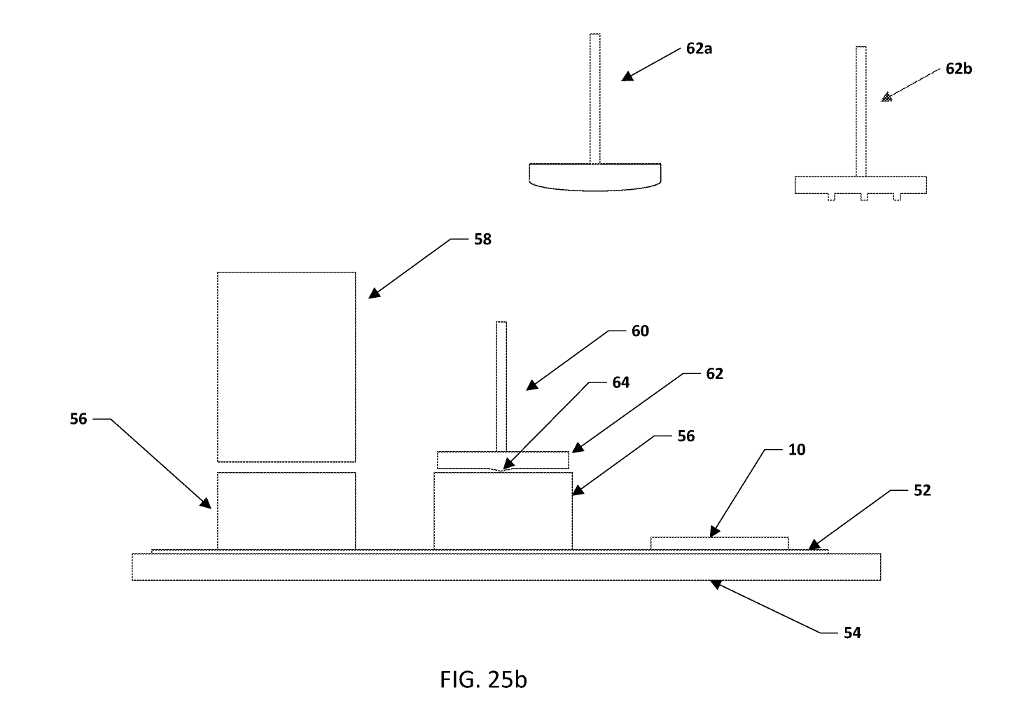

In certain embodiments, loose mulch is dried. The drying can be performed by applying heat and can reduce the moisture content of the loose mulch to less than 6%. Drying the loose mulch with heat has the additional benefits of halting decomposition, halting the odor related to decomposition, and also killing any organisms present within the loose mulch, such as insects, insect eggs, larvae, or weed spores. Next, the loose mulch may be added to a mold 56 as shown in FIG. 25b. The size and shape of the mold 56 may be chosen so that the size and shape of the resulting mulch tile 10 fits properly in a landscape having flowers and plants. In an exemplary embodiment, the mold 56 is an eight inch by eight inch square shape. The loose mulch may be smoothed by hand or vibrated within the mold 56 to a flat level. Alternatively, the loose mulch may be smoothed or vibrated within the mold 56 such that the loose mulch is built up to a higher level around the perimeter of the mold 56 as compared to the center. This arrangement provides for a more consistent density across the top surface of the resulting mulch tile 10. The mulch may be compressed in the mold as described below with reference to FIG. 25b.

In another embodiment, represented in FIG. 25a, the loose mulch is added to a conveyor system and slowly compressed between a top conveyor 90 and bottom conveyor 92. The conveyor system slowly compresses the mulch as the height between the top conveyor 90 and the bottom conveyor 92 narrows. The resulting compressed mulch can be cut into tiles of any length.

In some embodiments, the mulch can be compressed at a pressure between 12,250 psi and 17,000 psi. In one embodiment, the mulch is compressed at a pressure of 14,000 psi, which balances the factors of water penetration in the resulting mulch tile 10 with cohesiveness such that the tiles 10 are still able to stay together and travel/ship well.

The loose mulch can be dried and compressed as-is, or it can be dried (e.g. to approximately a 1% moisture content) and mixed with resin, sap, gum, or additional lignin prior to adding the mulch into the mold 56. In an exemplary embodiment, 528 grams of loose mulch is added to an eight inch by eight inch mold. This results in a mulch density of eight and twenty-five hundredths grams per square inch and a depth of approximately one-half of an inch. In this embodiment, after applying water the mulch tile can expand to a depth of two inches.

In certain embodiments, the mulch tile 10 can be scored or partially cut using the top conveyer, top plate, or a press. The scores or partial cuts can serve as break lines so that a user can break the mulch tile 10 into different sizes.

In an embodiment, which is schematically represented in FIG. 25b, landscape fabric 52 with perforations allowing for easy tearing/separation by a user is placed on a conveyor belt 54. One or more female molds 56 are then placed on top of the landscape fabric 52, and loose mulch, for example disposed in a hopper 58, is fed into the mold 56. The conveyor 54 then feeds the fabric/mulch toward a press 60 where a head 62 of the press, such as a plug, top plate, male piston, etc. compresses the loose mulch. The head 62 can include a convex shape 64 or one or more extension lines that imprint a concave cavity or one or more lines onto a top surface of the compressed mulch providing an area to collect water when the mulch is watered during use. Alternative embodiments of the head are shown in FIGS. 25b at 62a and 62b. In other embodiments, the head has a substantially flat surface such that no impression is made in the resulting top surface of the compressed mulch.

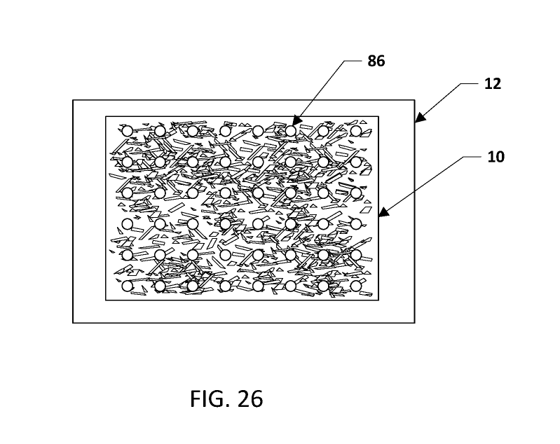

A concave feature in the resulting mulch tile 10 acts as a reservoir for water to pool and then penetrate the compressed mulch. The concave feature prevents water from sheeting off the mulch tile 10 and being wasted. The concave feature or features can be formed by compression into the top surface of the mulch tile 10 using a head 62 as described above, or it can be formed by a roller. In certain embodiments, the concave feature has an indentation depth equal to or greater than one tenth the depth of the mulch tile 10. In other embodiments as shown in FIG. 26, the mulch tile 10 can have embedded holes 86. In these embodiments, the holes 86 can be embedded into the mulch tile 10 by vertical compression or rollers. For example, pins (e.g. cone-shaped or rod-shaped) can project from a top plate, or a top conveyor used for compressing the mulch tiles. In another exemplary embodiment, the head 62 has pins projecting from its compression surface. In other embodiments, the holes 86 can be drilled. It should be appreciated that the holes 86 can penetrate the entire depth of the mulch tile 10, or the holes 86 can penetrate a portion of the depth of the mulch tile 10. In an exemplary embodiment, the pin or drill holes 86 can have a depth equal to or greater than one tenth of the depth of the tile. These pin or drill holes 86 can have any desired diameter. However, the best results are obtained with holes 86 having a diameter greater than one sixteenth of an inch and less than one half of an inch. For example, holes 86 having a diameter of one-eighth of an inch allow water to penetrate the tile, and when the tile expands, the holes are no longer visible. The holes 86 should also be spaced apart from each other such that when the mulch expands, the holes 86 disappear from view. In an exemplary embodiment, the holes 86 are spaced apart at a distance of one hole 86 per square inch on the mulch tile 10.

Turning back to FIG. 25b, as the head 62 compresses the mulch, lignin within the mulch is liquefied and self-distributed among the mulch particles to the fabric 52. When the head 62 is withdrawn thereby removing pressure from the mulch, the lignin solidifies thereby forming the dense mulch tile 10 that is adhered to the fabric 52 by the lignin. The tile 10 is then ejected from the mold. In an embodiment the tile 10 could be separated from the remainder of the fabric 52 by tearing/separating along the perforations. In another embodiment, a plurality of tiles 10 on fabric 52 are provided in an array as discussed above. The single tiles 10 or array can then be packaged together in any suitable manner, for example in a carrying case 20 or using a sleeve 40 as discussed above.

As described above, the landscape fabric 52 can be attached to a single mulch tile 10, a plurality of mulch tiles 10 that may be folded, or a plurality of mulch tiles 10 that may be rolled. The landscape fabric 52 may also function is a weed barrier, further enhancing the resulting landscape product's effectiveness in use. In a first exemplary embodiment, the landscape fabric 52 can be a biodegradable paper. This biodegradable paper can be added to the mold 56 or conveyor belt 54 before loose mulch is added. The biodegradable paper can be used dry or it can be made wet through a spray, sponge, or other application of water. In certain embodiments, the water is applied with a coverage of one hundredth mL/sq. in to six hundredths mL/sq. in. The compression of the mulch tile 10 binds the mulch tile to the biodegradable paper by liquefying lignin in the mulch. The application of water creates a better bond than using only the lignin naturally in the loose mulch. However, even without added water, a bond is still created between the mulch tile 10 and the biodegradable paper. The biodegradable paper can be cut, pierced, or perforated to create one or more tabs that extend upwards before the mulch is added. These tabs act as appendages that can be compressed between the mulch to further bind the mulch to the biodegradable paper. Biodegradable pins can also be pushed through the biodegradable paper before mulch is added to the mold. These pins also act as appendages that can be compressed between the mulch to further bind the mulch to the biodegradable paper.

In a second exemplary embodiment, the landscape fabric 52 can be biodegradable cardboard. This biodegradable cardboard can be added to the mold 56 or conveyor belt 54 before loose mulch is added. The biodegradable cardboard can be used dry or it can be made wet through a spray, sponge, or other application of water. In certain embodiments, the water is applied with a coverage of one hundredth mL/sq. in to thirteen hundredths mL/sq. in. The compression of the mulch tile 10 binds the mulch tile to the biodegradable cardboard by liquefying lignin in the mulch. The application of water creates a better bond than using only the lignin naturally in the loose mulch. However, even without added water, a bond is still created between the mulch tile 10 and the biodegradable cardboard. The biodegradable cardboard can be cut, pierced, or perforated to create one or more tabs that extend upwards before the mulch is added. These tabs act as appendages that can be compressed between the mulch to further bind the mulch to the biodegradable cardboard. Biodegradable pins can also be pushed through the biodegradable cardboard before mulch is added to the mold. These pins also act as appendages that can be compressed between the mulch to further bind the mulch to the biodegradable cardboard.

In a third exemplary embodiment, the landscape fabric 52 can be synthetic or natural landscape fabric such as a weed barrier. This landscape fabric 52 can be added to the mold 56 or conveyor belt 54 before loose mulch is added. The landscape fabric 52 can be used dry or it can be made wet through a spray, sponge, or other application of water, resin, sap, gum, or additional lignin. In certain embodiments, the water, resin, sap, gum, or lignin is applied with a coverage of one thousandth mL/sq. in to two tenths mL/sq. in. The compression of the mulch binds the mulch tile 10 to the landscape fabric by liquefying lignin in the mulch. The application of water, resin, sap, gum, or additional lignin creates a better bond than using only the lignin naturally in the loose mulch. However, even without added water, resin, sap, gum, or lignin, a bond is still created between the mulch tile 10 and the landscape fabric 52. The landscape fabric 52 can be cut, pierced, or perforated to create one or more tabs that extend upwards before the mulch is added. These tabs act as appendages that can be compressed between the mulch to further bind the mulch to the landscape fabric 52. Biodegradable pins can also be pushed through the landscape fabric 52 before mulch is added to the mold. These pins also act as appendages that can be compressed between the mulch to further bind the mulch to the landscape fabric 52.

In another embodiment, a female mold is placed on a conveyor belt and loose mulch, for example disposed in a hopper, is fed into the mold. The conveyor then feeds the mulch toward a press where a head of the press, such as a plug, top plate, male piston, etc. compresses the loose mulch. The head can include a convex shape or one or more extension lines that imprint a concave cavity or one or more lines onto a top surface of the compressed mulch providing an area to collect water when the mulch is watered during use. As the head compresses the mulch, lignin within the mulch is liquefied and self-distributed among the mulch particles. When the head is withdrawn thereby removing pressure from the mulch, the lignin solidifies thereby forming the dense mulch tile. The tile is then ejected from the mold. The tile can then optionally be attached to landscape fabric, for example by a water-soluble glue, resin, sap, gum, lignin, staple(s), nail(s), screw(s), holes/plugs, fabric pin(s), etc.

In an embodiment, each tile can be attached to its own fabric as shown in FIG. 3. In another embodiment, a plurality of tiles can be attached to fabric in an array as shown in FIG. 5. The single tiles or array can then be packaged together in any suitable manner, for example in a carrying case 20 or using a sleeve 40 as discussed above. If the tile is attached to the fabric using a fabric pin, for example, the pin can be pressed through the tile and fabric, and then when installed on a ground surface, the pin pressed into the ground to hold the fabric in place.

In still another embodiment, landscape fabric with perforations allowing for easy tearing/separation by a user is placed on a conveyor belt. Separately, loose mulch is mixed with an adhesive, such as a water-soluble glue, resin, sap, gum, or lignin. The mixture is then distributed across the fabric on the conveyor belt, for example evenly distributed across a width of the fabric. The conveyor then feeds the fabric and mixture through a shaping/compression roll, or a series of rollers (heated or unheated), that compacts the mixture to a predetermined shape, size, and thickness. The roll can include a convex shape or one or more extension lines that imprint a concave cavity or one or more lines onto a top surface of the mixture providing an area to collect water when the mulch is watered during use. The conveyor then feeds the fabric and compressed mixture through an oven or suitable dryer to dry the mixture to the fabric, and then the finished product is removed from the oven. In an embodiment the tiles could be separated from the remainder of the fabric by tearing/separating along the perforations. In another embodiment, a plurality of tiles on fabric are provided in an array as discussed above. The single tiles or array can then be packaged together in any suitable manner, for example in a carrying case 20 or using a sleeve 40 as discussed above.

In still another embodiment, landscape fabric with perforations allowing for easy tearing/separation by a user is placed on a conveyor belt. The loose mulch is then distributed across the fabric on the conveyor belt, for example evenly distributed across a width of the fabric. The conveyor then feeds the fabric and loose mulch through a shaping/compression roll, or a series of rollers (heated or unheated), that compacts the mixture to a predetermined shape, size, and thickness. The roll can include a convex shape or one or more extension lines that imprint a concave cavity or one or more lines onto a top surface of the mulch providing an area to collect water when the mulch is watered during use. The conveyor then feeds the fabric and compressed mulch through an oven or suitable dryer to dry the mixture to the fabric, and then the finished product is removed from the oven. In an embodiment the tiles could be separated from the remainder of the fabric by tearing/separating along the perforations. In another embodiment, a plurality of tiles on fabric are provided in an array as discussed above. The single tiles or array can then be packaged together in any suitable manner, for example in a carrying case 20 or using a sleeve 40 as discussed above.

In yet another embodiment, loose mulch is mixed with an adhesive, such as a water-soluble glue, resin, sap, gum, or lignin, and the mixture is distributed across a conveyor belt, for example evenly distributed across a width of the conveyor belt. The conveyor then feeds the mixture through a shaping/compression roll, or a series of rollers (heated or unheated), that compacts the mixture to a predetermined shape, size, and thickness. The roll can include a convex shape or one or more extension lines that imprint a concave cavity or one or more lines onto a top surface of the mixture providing an area to collect water when the mulch is watered during use. The conveyor then feeds the compressed mixture through an oven or suitable dryer to dry the mixture, and then the finished product is removed from the oven. In an embodiment the finished product is a length of compressed mulch that is cut into individual tiles after removal from the oven. The tile can then optionally be attached to landscape fabric, for example by a water-soluble glue, staple(s), nail(s), screw(s), holes/plugs, fabric pin(s), etc., either individually or in an array. The single tiles or array can then be packaged together in any suitable manner, for example in a carrying case 20 or using a sleeve 40 as discussed above.

In yet another embodiment, loose mulch is distributed across a conveyor belt, for example evenly distributed across a width of the conveyor belt. The conveyor then feeds the loose mulch through a shaping/compression roll, or a series of rollers (heated or unheated), that compacts the mulch to a predetermined shape, size, and thickness. The roll can include a convex shape or one or more extension lines that imprint a concave cavity or one or more lines onto a top surface of the mulch providing an area to collect water when the mulch is watered during use. The conveyor then feeds the compressed mulch through an oven or suitable dryer to dry the mixture, and then the finished product is removed from the oven. In an embodiment the finished product is a length of compressed mulch that is cut into individual tiles after removal from the oven. The tile can then optionally be attached to landscape fabric, for example by a water-soluble glue, staple(s), nail(s), screw(s), holes/plugs, fabric pin(s), etc., either individually or in an array. The single tiles or array can then be packaged together in any suitable manner, for example in a carrying case 20 or using a sleeve 40 as discussed above.

In a further embodiment, landscape fabric with perforations allowing for easy tearing/separation by a user is placed on a conveyor belt and one or more female molds are then placed on top of the landscape fabric. Loose mulch is mixed with an adhesive, such as a water-soluble glue, resin, sap, gum, or lignin, and the mixture is disposed in a hopper and fed into the mold. The conveyor then feeds the fabric/mixture toward a press where a head of the press, such as a plug, top plate, male piston, etc. compresses the mixture. The head can include a convex shape or one or more extension lines that imprint a concave cavity or one or more lines onto a top surface of the compressed mulch providing an area to collect water when the mulch is watered during use.

During compression, the adhesive will self-distribute among the mulch particles and the landscape fabric. When the head is withdrawn thereby removing pressure from the mulch, a dense mulch tile adhered to the landscape fabric results. The tile is then ejected from the mold. The single tiles or array can then be packaged together in any suitable manner, for example in a carrying case 20 or using a sleeve 40 as discussed above.

In still another embodiment, one or more female molds are placed on top of a conveyor belt. Loose mulch is mixed with an adhesive, such as a water-soluble glue, resin, sap, gum, or lignin, and the mixture is disposed in a hopper and fed into the mold. The conveyor then feeds the mixture toward a press where a head of the press, such as a plug, top plate, male piston, etc. compresses the mixture. The head can include a convex shape or one or more extension lines that imprint a concave cavity or one or more lines onto a top surface of the compressed mulch providing an area to collect water when the mulch is watered during use.

During compression, the adhesive will self-distribute among the mulch particles. When the head is withdrawn thereby removing pressure from the mulch, a dense mulch tile results. The tile is then ejected from the mold. The tile can then optionally be attached to landscape fabric, for example by a water-soluble glue, resin, sap, gum, lignin, staple(s), nail(s), screw(s), holes/plugs, fabric pin(s), etc., either individually or in an array. The single tiles or array can then be packaged together in any suitable manner, for example in a carrying case 20 or using a sleeve 40 as discussed above.

It will be appreciated that in the above embodiments, the lignin and/or adhesive may be used separately, in combination with one another, or may replace one another.

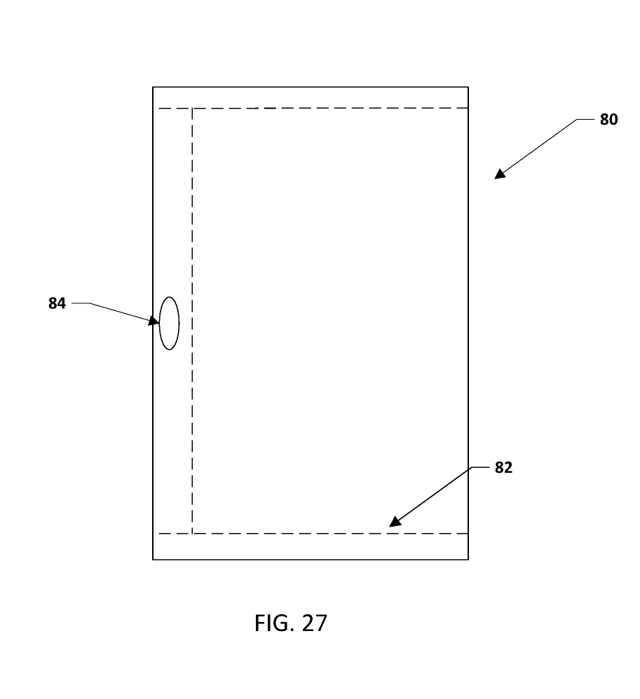

Turning now to FIG. 27, an exemplary mulch receptacle is shown at reference numeral 80. The mulch receptacle 80 can hold loose mulch or compressed mulch in any form, such as chunks, tiles, etc., and can be formed of landscape fabric. The receptacle can be formed in any suitable manner, such as by folding a sheet of landscape fabric in half and then closing the sides and top by quick release stitches 82 that are biodegradable. The sides can be closed by the stitch 82 and then the receptacle filled with mulch at the top and then the top would be closed by the stitch 82, or one of the sides and top can be closed by the stitch 82 and then the receptacle filled with mulch at the other side and then the other side would be closed by the stitch 82 as shown in FIG. 27, or the receptacle can be filled with mulch and then the sides and top closed. In an embodiment, the receptacle 80 can have handles 84 formed in the fabric for carrying the receptacle.

During use, the receptacle 80 can be moved to a desired location and set on the ground and the quick release stitches 82 can be removed. The landscape fabric can then be unfolded and the mulch spread around on top of the fabric thereby providing a mulched area with the fabric providing a barrier, for example to weeds, underneath the mulch. It will of course be appreciated that the mulch could be spread on top of an existing ground covering and the fabric not utilized.

In an embodiment, a mulch tile may be formed according to any of the above methods but without being attached to a landscape fabric. The mulch tile could then be sealed in a suitable manner, such as by coating the mulch tile with an epoxy or other waterproof coating. In this way, the mulch tile could be used for indoor or outdoor use, such as a floor or wall tile.

The aforementioned elements, (e.g., mulch tiles, fabric, among others), and the like have been described with respect to interaction between several components and/or elements. It should be appreciated that such devices and elements can include those elements or sub-elements specified therein, some of the specified elements or sub-elements, and/or additional elements. Further yet, one or more elements and/or sub-elements may be combined into a single component to provide aggregate functionality. The elements may also interact with one or more other elements not specifically described herein.

While the embodiments discussed herein have been related to the systems and methods discussed above, these embodiments are intended to be exemplary and are not intended to limit the applicability of these embodiments to only those discussions set forth herein.

The above examples are merely illustrative of several possible embodiments of various aspects of the present invention, wherein equivalent alterations and/or modifications will occur to others skilled in the art upon reading and understanding this specification and the annexed drawings. In particular regard to the various functions performed by the above described components (assemblies, devices, systems, circuits, and the like), the terms (including a reference to a “means”) used to describe such components are intended to correspond, unless otherwise indicated, to any component, such as hardware, software, or combinations thereof, which performs the specified function of the described component (e.g., that is functionally equivalent), even though not structurally equivalent to the disclosed structure which performs the function in the illustrated implementations of the invention. In addition although a particular feature of the invention may have been disclosed with respect to only one of several implementations, such feature may be combined with one or more other features of the other implementations as may be desired and advantageous for any given or particular application. Also, to the extent that the terms “including”, “includes”, “having”, “has”, “with”, or variants thereof are used in the detailed description and/or in the claims, such terms are intended to be inclusive in a manner similar to the term “comprising.”

This written description uses examples to disclose the invention, including the best mode, and also to enable one of ordinary skill in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that are not different from the literal language of the claims, or if they include equivalent structural elements with insubstantial differences from the literal language of the claims.

In the specification and claims, reference will be made to a number of terms that have the following meanings. The singular forms “a”, “an” and “the” include plural referents unless the context clearly dictates otherwise. Approximating language, as used herein throughout the specification and claims, may be applied to modify a quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Moreover, unless specifically stated otherwise, a use of the terms “first,” “second,” etc., do not denote an order or importance, but rather the terms “first,” “second,” etc., are used to distinguish one element from another.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be.”

The best mode for carrying out the invention has been described for purposes of illustrating the best mode known to the applicant at the time and enable one of ordinary skill in the art to practice the invention, including making and using devices or systems and performing incorporated methods. The examples are illustrative only and not meant to limit the invention, as measured by the scope and merit of the claims. The invention has been described with reference to preferred and alternate embodiments. Obviously, modifications and alterations will occur to others upon the reading and understanding of the specification. It is intended to include all such modifications and alterations insofar as they come within the scope of the appended claims or the equivalents thereof. The patentable scope of the invention is defined by the claims, and may include other examples that occur to one of ordinary skill in the art. Such other examples are intended to be within the scope of the claims if they have structural elements that do not differentiate from the literal language of the claims, or if they include equivalent structural elements with insubstantial differences from the literal language of the claims.

What is claimed is:

1. A landscape product comprising:
a compressed mulch tile having a top surface, a bottom surface, and a height between the top and bottom surfaces; and
a sheet of landscape fabric adhered to the bottom surface of the compressed mulch tile,
wherein the compressed mulch tile is loose mulch that has been dried, compressed and adhered together.

2. The landscape product according to claim 1, further comprising a plurality of compressed mulch tiles, wherein the plurality of compressed mulch tiles are arranged on the sheet of landscape fabric, in an array spaced from one another.

3. The landscape product according to claim 2, wherein the array of compressed mulch tiles on the fabric is folded and stitched together with a biodegradable stitch to form a carrying case.

4. The landscape product according to claim 1, wherein the top surface of the compressed mulch tile has a concave indentation.

5. The landscape product according to claim 4, wherein the concave indentation has an indentation depth that is at least 1/10^{th} of the height of the tile.

6. The landscape product according to claim 1, wherein the top surface of the compressed mulch tile comprises a plurality of holes.

7. The landscape product according to claim 6, wherein each of the plurality of holes has a diameter greater than 1/16th of an inch, but less than ½ of an inch.

8. The landscape product according to claim 6, wherein the plurality of holes are spaced at approximately one hole per square inch.

9. A method of forming a compressed mulch tile, the method including:
placing a sheet of landscape fabric on a conveyor belt;
placing a mold on top of the landscape fabric;
drying loose mulch;
feeding the loose mulch into the mold;
pressing the loose mulch with a press, forming the loose mulch into a compressed mulch tile on top of the sheet of landscape fabric; and
removing the press from the mold.

10. The method according to claim 9, further comprising:
applying at least one of water, resin, sap, gum, or lignin to a surface of the sheet of landscape fabric before forming the compressed mulch tile on top of the sheet of landscape fabric.

11. The method according to claim 9, wherein the sheet of landscape fabric includes perforations at spaced intervals from one another to allow for separation of mulch tiles.

12. The method according to claim 9, wherein the press includes a head having a convex shape and/or one or more extension lines that imprint a concave cavity and/or one or more lines onto a top surface of the compressed mulch.

13. The method according to claim 9, wherein as the press compresses the loose mulch, lignin within the mulch is liquefied and self-distributed among mulch particles to hold the mulch particles together and to hold the mulch to the landscape fabric.

14. The method according to claim 9, further comprising:
mixing a water-soluble adhesive with the loose mulch before feeding the loose mulch into the mold.

15. The method according to claim 9, wherein the loose mulch is dried to less than 6% moisture content.

16. The method according to claim 9, wherein the loose mulch is pressed at a pressure between 12,250 psi and 17,000 psi.

17. The method according to claim 9, wherein the mulch is dried to approximately 1% moisture content, and a resin, sap, gum, or lignin is mixed with the loose mulch.

18. The method according to claim 9, further comprising:
embedding holes into the compressed mulch tile.

19. The method according to claim 18, wherein the holes are greater than 1/16 of an inch and less than ½ of an inch.

20. A method of manufacturing a landscape product, the method including:
drying loose mulch;
compressing a first portion of the loose mulch, forming the first portion of loose mulch into a first compressed mulch tile;
adhering the first compressed mulch tile to a landscape fabric;
compressing a second portion of the loose mulch, forming the second portion of loose mulch into a second compressed mulch tile;
adhering the second compressed mulch tile to the landscape fabric spaced a distance away from the first compressed mulch tile;
folding or rolling the landscape fabric to contain the first compressed mulch tile and the second compressed mulch tile; and
fastening the landscape fabric to at least partially enclose the first compressed mulch tile and the second compressed mulch tile within the landscape fabric.
